(19) United States
(12) Patent Application Publication
(10) Pub. No.: US 2011/0211046 A1
(43) Pub. Date: Sep. 1, 2011

(54) MULTI-CAMERA SYSTEM AND A METHOD FOR CALIBRATING THE SAME

(76) Inventors: Tobias Stumber, Rutesheim (DE); Ralf Render, Leonberg (DE); Fridtjof Stein, Ostfildern (DE)

(21) Appl. No.: 12/737,647

(22) PCT Filed: Jul. 17, 2009
(86) PCT No.: PCT/EP2009/059204

§ 371 Date: May 11, 2011

(30) Foreign Application Priority Data
Aug. 5, 2008 (DE) 102008040985.5

(51) Int. Cl. H04N 13/02

(52) U.S. Cl. 348/47; 348/E13.074

(57) ABSTRACT

In a method for calibrating a multi-camera system having at least two cameras spaced at a distance from one another, the cameras are aligned with one another with respect to their optical axes. The cameras are used for supplying three-dimensional image information, and the multi-camera system is situated on a vehicle. The position of the cameras relative to one another, in particular the alignment of their optical axes relative to one another, is retained unchanged before, during and after the calibration, and the cameras are calibrated by electronic processing of image information from at least one of the cameras.

### BACKGROUND OF THE INVENTION

1. Field of the Invention

The present invention relates to a method for calibrating a multi-camera system having at least two cameras spaced at a distance from one another, the cameras having electronic image sensors, during calibration the cameras being aligned with one another with respect to their optical axes, and the cameras being used in particular for supplying three-dimensional image information, and the multi-camera system furthermore preferably being situated on a vehicle.

2. Description of the Related Art

When multi-camera systems, in particular stereo camera systems, are used, a calibration of the two cameras is necessary for accurately obtaining image information. In this connection, a distinction is made between internal and external calibration, the alignment of the at least two cameras, in particular their position relative to one another, being considered in external calibration. In the related art, it is customary for this purpose to use the cameras in a defined environment having known objects (targets) and to compare the image information thus obtained with respect to the correspondence of both camera images or with respect to their image information deviating on the basis of the desired three dimensional representation, and, accordingly, to adjust the mechanical position of the cameras or at least one of the cameras relative to at least one other camera. In this connection, a defined environment, namely at least one target, is presumed. In particular, it is regularly necessary for this purpose to place the camera system in a defined environment, which is associated with a considerable amount of time and money. When manufacturing such multi-camera systems, an appropriate initial calibration is performed, this process requiring a considerable amount of time and money, in particular for suppliers, and presuming that very low installation tolerances of the multi-camera system are met, in particular when the multi-camera system is used in vehicles.

An object of the present invention is to provide a method that simplifies the calibration of multi-camera systems and makes it more cost-effective, in particular in such a way that defined environments and/or targets may be dispensed with. In particular, online calibration should be made possible at any points in time.

To this end, a method is described for calibrating a multi-camera system having at least two cameras spaced at a distance from one another, the cameras having electronic image sensors, during calibration the cameras being aligned with one another with respect to their optical axes, and the cameras being used in particular for supplying three-dimensional image information, and the multi-camera system furthermore preferably being situated on a vehicle. In this connection, it is provided that the position of the cameras relative to one another, in particular the alignment of their optical axes relative to one another, is retained unchanged before, during, and after the calibration, and the cameras are calibrated by electronic processing of image information of at least one of the cameras. In contrast to the related art, the position of at least one camera relative to at least one of the other cameras is consequently not changed for calibrating the multi-camera system; in particular the optical axes of the cameras relative to one another are not changed. Instead, the image information of at least one of the cameras is modified by electronic processing in such a way that the cameras are calibrated, thus resulting in one camera accurately obtaining image information of the entire multi-camera system. This process is performed in particular by a calculation specification which is executed in a computation unit, the computation unit possibly being a component of the multi-camera system or else being situated externally, for example in a vehicle computer or vehicle control unit.

In one embodiment of the method it is provided that the image information of at least one of the cameras has at least one offset for the calibration. In this connection, an offset is a deviation in vertical or horizontal direction with regard to the position of the image information on the image sensor, this offset causing the image of the camera to be shifted in the direction of the offset.

In one further embodiment of the method, the image information of at least one of the cameras is inclined on at least one defined axis for the calibration. This means that the image obtained through the image information is shifted into a relative position, which is changed with respect to the image's original position as namely obtained from the image sensor, namely inclined in particular. After this step is performed, the image thus has a changed position, namely an inclined position, compared to the image originally obtained from the camera's sensor.

In another embodiment of the method, the image information of at least one of the cameras is tilted on at least one defined axis for the calibration. This means that, similar to the inclining, an image as obtained from the camera's image sensor is tilted, i.e., tilted (rotated) at a specific angle, in particular on the optical axis.

Preferably a partial image of an image supplied by the at least one camera is used for the calibration. The use of a partial image allows a wide use of both the X and Y offsets as well as inclining and tilting (rotating) without the image information on the margins being lost.

A disparity table is preferably used for the calibration. A disparity table records correspondences of the camera images found on a two dimensional field. This means that a record is made of the number of correspondences of images/image information of the individual cameras present and the number of these correspondences is registered in the disparity table.

It is particularly preferable that the disparity table represents an uneven number of columns relative to a vertical offset (Y offset). For example, the Y offset of an image or of a partial image is thus plotted in the first column, namely of the camera whose image information is changed electronically for calibration. In the other columns, namely in an uneven number of additional columns, the correspondence of the images or partial images compared in this manner is outlined, so that a specific number of image correspondences results for each offset and each column. For example, the offset column may be such that an offset of −2, −1, 0, +1, +2 is provided, and subsequently five columns with respect to the image information are provided. A specific number of image correspondences then results in each column for each offset (as seen in the first column).

It is particularly preferable that the calibration is performed by repeatedly passing through the disparity table using a different Y offset and/or a different inclination and/or a different tilt in each case. Thus, a new pass is made through the disparity table in the case of a different offset, a different inclination and/or a different tilt of the image or partial image of at least one of the cameras present.

In a particularly preferred embodiment of the method, the Y offset and/or the inclination and/or the tilt of one of the images/partial images is performed after a maximum of correspondences (image correspondences) is shown in the disparity table. This means that a selection is made of the column and offset in which a maximum of image correspondences is present. The method is implemented iteratively in such a way that a maximum of correspondences is found, for example, at an offset of 0 in column 3. At an offset of −1, a maximum of correspondences is found in column 4, and at an offset of −2, a maximum is found in column 5. Accordingly, at an offset of +1, a maximum is found in column 2, and at an offset of +2, a maximum is found in column 1. This results in the image of the camera to be calibrated of the multi-camera system having to undergo an inclination relative to its optical axis; thus the image is tilted, i.e., electronically rotated. The offset settings are immediately passed through again in order to determine if an additional tilt is necessary or if an optimal correspondence was found. In one embodiment of the method, the camera on the right of two cameras is calibrated. This allows for a given, standardized method having simple calculation. Naturally, the calibration of the left camera is also possible; the only important criterion is that the method is consistently implemented in the same manner; the use of one camera is sufficient.

Furthermore, a multi-camera system is described having at least two cameras spaced at a distance from one another, in particular for implementing the method as described above. In this connection, it is provided that the multi-camera system has a computation unit for calibrating the cameras with respect to their optical axes relative to one another. In the related art, the cameras of multi-camera systems are calibrated by way of mechanical adjustment of at least one of the cameras relative to the other camera. In contrast, in the multi-camera system described here, it is provided that the calibration is not performed via a mechanical adjustment but instead via a computation unit. In doing so, the computation unit processes the image information obtained from the cameras of the multi-camera system.

It is furthermore preferably provided that the optical axes and/or the mechanical positioning of the cameras relative to one another is/are unchanged before, during and after the calibration. The multi-camera system is calibrated solely by way of calculation without any change of the cameras relative to one another. This means that mechanical adjustment devices, in particular 3D tilters, such as are necessary for calibrating in the related art (namely for at least one of the cameras of the multi-camera system), are completely unnecessary for the calibration.

### BRIEF DESCRIPTION OF THE DRAWINGS

FIG. 1 shows a schematic representation of a multi-camera system having two cameras (stereo camera system).

FIG. 2 shows a disparity table for calibrating the multi-camera system.

### DETAILED DESCRIPTION OF THE INVENTION

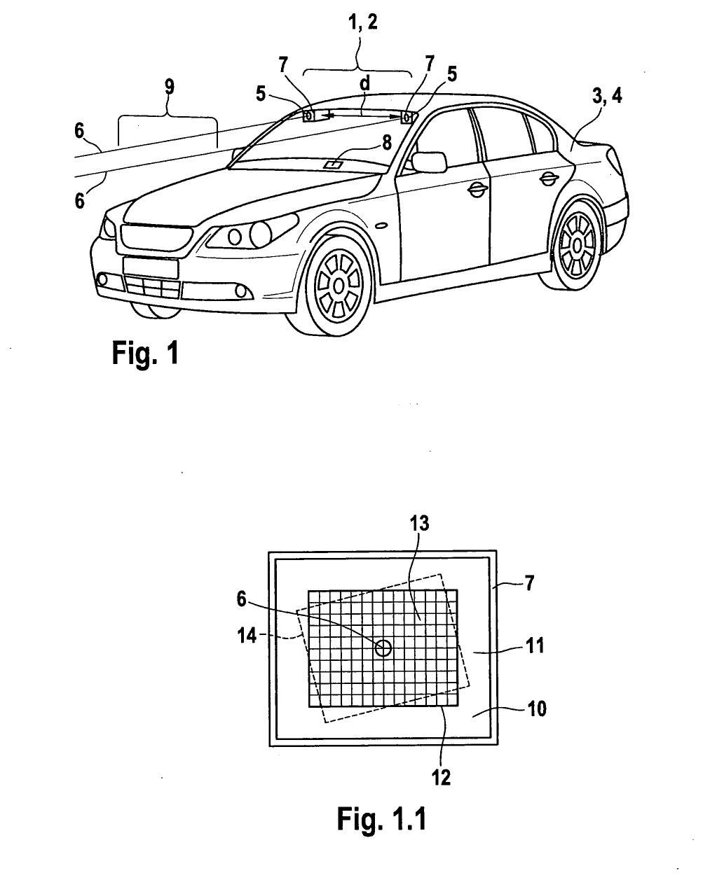

FIG. 1 shows a schematic view of a multi-camera system 1, namely a stereo camera system 2 on a vehicle 3, namely a motor vehicle 4. Multi-camera system 1 has two cameras 5 spaced at a distance d from one another, each of them having an optical axis 6 which runs in the direction of detection of an electronic image sensor 7 situated in camera 5 and perpendicular to it. Via suitable electrical connections (not shown here), cameras 5 are connected to a computation unit 8 which evaluates and further processes the image information obtained from cameras 5, in particular for calibrating multi-camera system 1. Optical axes 6 of both cameras 5 of multi-camera system 1 have alignment 9 with respect to one another. Electrical image sensor 7 is shown in Sub-FIG. 1.1 having an image area 10 to which image 11 obtained from image sensor 7 corresponds. Of this image 11, only a partial image 12 is used by computation unit 8 shown in FIG. 1 for the further processing of image information 13 present in partial image 12. In the course of a calibration of multi-camera system 1, partial image 12 is, for example, rotated on optical axis 6 of image sensor 7, resulting in a rotated partial image 14. Furthermore, it may be shifted in the X and Y directions, resulting in an offset relative to the starting position of partial image 12. Rotating and shifting is accomplished electronically, for example, by selecting other lines and columns of image sensor 7.

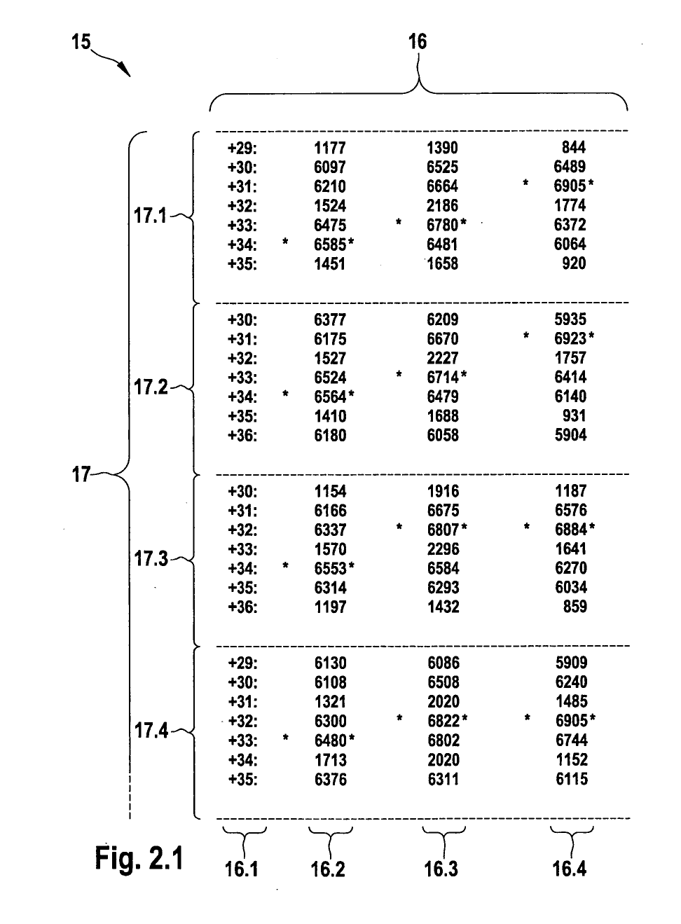

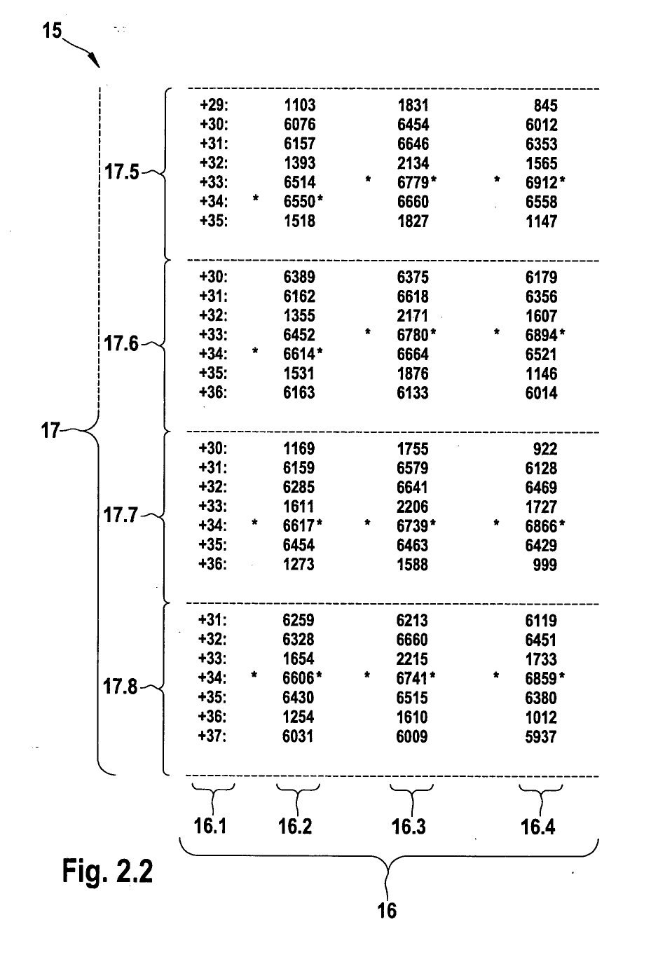

FIG. 2 (being made up of FIG. 2.1 and FIG. 2.2) shows by way of example a course of procedure of the electronic calibration of multi-camera system 1 described in FIG. 1 using a disparity table 15, the position of optical axes 6 relative to one another (in particular their alignment 9) and the position of cameras 5 relative to one another remaining unchanged. This disparity table 15 has four columns 16, of which a vertical offset (Y offset) of partial image 12 relative to image 11 (respectively of image area 10) of image sensor 7 is plotted in first column 16 point 1, and the numbers of the found correspondences (image correspondences) of partial images 12 of both cameras 5 are plotted in the three additional columns 16.2, 16.3 and 16.4; partial images 12 of both cameras 5 are therefore compared for the purpose of the calibration, a check being made of how great the number of correspondences of both partial images 12 of both cameras is in each case. These correspondences make it possible to evaluate the alignment and relative position of both cameras 5 relative to one another for the purpose of operating multi-camera system 1. One of the two partial images 12, namely of one of cameras 5, for example, of right camera 5, is shifted for this purpose using the shown Y offsets within image area 10, while partial image 12 of the other camera is not changed. In this connection, partial image 12 of each camera 5 is subdivided into three vertical sections which are checked for image correspondences (correspondences); one of columns 16.2, 16.3 or 16.4 of disparity table 15 corresponds to each of the three vertical sections. In the present example, the correspondences are checked for each of the seven different offsets for each of the three vertical sections of partial image 12 of the two cameras. In doing so, blocks 17 are formed. Offsets of +29 to +35 are plotted in first block 17.1. The numerical values shown in columns 16.2 to 16.4 are exemplary for the correspondences of both partial images 12 found in the respective vertical section of partial image 12. Accordingly, a correspondence with respect to 6585 points results in column 16.2 for the first vertical section at an offset of +34; a correspondence with respect to 6780 points results in column 16.3 for the second vertical section at a Y offset of +33, and a correspondence of 6905 points results in column 16.4 for the third vertical section at a Y offset of +31. The center vertical section shown in column 16.3 is used as the starting point. The highest correspondence of 6780 points arises there, as mentioned, at a Y offset of +33. Accordingly, the new Y offset to be used for the next step of the calibration is +33. In second block 17.2, the new Y offset of +33 is placed in the center of the series of the offset, resulting in a Y offset of +30 to +36, +33 lying in the center. This results in a correspondence of 6564 points for a Y offset of +34 in the first vertical section (column 16.2), a correspondence of 6714 points for the second vertical section at a Y offset of +33 in third column 16.3, and a correspondence of 6923 points for the third vertical section at a Y offset of +31 in fourth column 16.4. As a result partial image 12 must be inclined relative to the image area because the largest number of image correspondences at 6714 correspondences now lies in the center, namely at a Y offset of +33 and in the second vertical section. Accordingly, partial image 12 is tilted, i.e., rotated slightly on optical axis 6 (see FIG. 1.1). Additional blocks 17.3 to 17.7 are now passed through until it is determined in block 17.7 that at a Y offset of +34 in columns 16.2 to 16.4 for the three vertical sections of partial image 12, the largest number of all image correspondences is at the stated Y offset of +34, i.e., all on one Y position. However, this Y position at a Y offset of +34 is not situated in the center of block 17.7; such a centering of Y offset +34 occurs centered in vertical alignment in step 17.8, so that the greatest possible correspondence is found both in vertical and in horizontal alignment. In this connection, the calibration of multi-camera system 1 is completed by purely electronic processing of the image information obtained from cameras 5, namely the shifting of partial image 12 and its rotation on optical axis 6, without the necessity of changing the position of cameras 5 relative to one another and in particular their optical axes 6 relative to one another (in their alignment 9). This allows in particular a rapid online calibration and recalibration of camera system 1 and makes complex mechanical designs, which are in addition susceptible to all kinds of mechanical influences, superfluous. Disparity table 15 described above is created and managed in described computation unit 8; computation unit 8 ensures that obtained image information 13 is processed appropriately.

1-12. (canceled)

13. A method for calibrating a multi-camera system having at least two cameras spaced at a distance from one another and having electronic image sensors, the cameras being used for supplying three-dimensional image information, the method comprising:
aligning the optical axes of the two cameras relative one another; and
calibrating the two cameras by electronic processing of image information from at least one of the two cameras, wherein the alignment of the optical axes of the two cameras is maintained unchanged before, during and after the calibration.

14. The method as recited in claim 13, wherein the image information of at least one of the cameras is provided with at least one offset for the calibration.

15. The method as recited in claim 14, wherein the image information of at least one of the cameras is inclined on at least one defined axis for the calibration.

16. The method as recited in claim 14, wherein the image information of at least one of the cameras is tilted on at least one defined axis for the calibration.

17. The method as recited in claim 16, wherein a partial image of an image supplied by the at least one camera is used for the calibration.

18. The method as recited in claim 16, wherein a disparity table is used for the calibration.

19. The method as recited in claim 18, wherein the disparity table represents an uneven number of columns relative to at least one of a vertical offset and a selected tilt.

20. The method as recited in claim 19, wherein the calibration is performed by repeatedly passing through the disparity table using a different vertical offset in each case.

21. The method as recited in claim 19, wherein during the calibration, the at least one of the vertical offset and the selected tilt of one of the images of at least one of the cameras is performed after a maximum of image correspondences shown in the disparity table.

22. The method as recited in claim 19, wherein the right-side camera of the two cameras is calibrated.

23. A multi-camera system, comprising:
at least two cameras spaced at a distance from one another and having electronic image sensors;
a computation unit configured to calibrate the cameras with respect to alignment of the optical axes of the two cameras relative to one another, wherein the calibration includes electronic processing of image information from at least one of the two cameras, the electronic processing including providing the image information of at least one of the cameras with at least one offset.

24. The multi-camera system as recited in claim 23, wherein the alignment of the optical axes of the two cameras relative to one another is unchanged before, during and after the calibration.
